(19) United States
(12) Patent Application Publication
(10) Pub. No.: US 2010/0017315 A1
(43) Pub. Date: Jan. 21, 2010

(54) RESOURCE-ALLOCATION PROCESSING SYSTEM AND APPROACH WITH ADAPTIVE-ASSESSMENT PROCESSING

(76) Inventor: Dean W. Hahn-Carlson, Lilydale, MN (US)

Correspondence Address: CRAWFORD MAUNU PLLC, 1150 NORTHLAND DRIVE, SUITE 100, ST. PAUL, MN, 55120, US

(21) Appl. No.: 12/506,956

(22) Filed: Jul. 21, 2009

Related U.S. Application Data
(60) Provisional application No. 61/082,434, filed on Jul. 21, 2008.

(51) Int. Cl. G06Q 40/00; G06Q 10/00

(52) U.S. Cl. 705/30

(57) ABSTRACT

Adaptive transaction data processing and analysis is carried out using inputs that are dynamically responsive. Embodiments of the present invention are directed to a computer-based system and related linking database that are configured to adaptively generate and output audit and electronic resource allocation data (e.g., payment data) based upon tracking fields that dynamically change across a multitude of disparate transactions.

### RELATED PATENT DOCUMENTS

This patent document claims the benefit, under 35 U.S.C. § 119(e), of U.S. Provisional Patent Application Ser. No. 61/082,434 filed on Jul. 21, 2008, and entitled “Payment Processing System and Approach with Adaptive-Assessment Processing;” this patent document is fully incorporated herein by reference.

### FIELD OF THE INVENTION

The present invention is directed to transaction processing and, more specifically, to control centers (and arrangements), such as those used in a control center of a financial institution to facilitate an auditing and processing system.

### BACKGROUND

A variety of different applications involve managing and providing of resources to disparate entities, based upon combinations of entities, the entities' respective needs and operational capabilities, and characteristics of available resources. For example, bandwidth resources applicable to the communication of data are implemented based upon different conditions, such as those relating to the quality of service, price or the location/identity of the source and recipient for data transfer. Other applications involve providing credit resources for funding financial transactions between participants. Energy resources, such as power grid or natural gas resources, are often allocated and delivered under varying conditions from different suppliers, often based upon the service type (e.g., continuous or variable/off-peak) or other characteristic of an end user. In a computing environment, processing resources are often managed based upon characteristics of a processing-type of transaction (e.g., a system component vying for processing time to perform a task). In each of these applications, resources available are provided based upon conditions of each instance in which allocation is to take place, and may involve different characteristics that dictate the availability and use of resources, which may further depend upon characteristics of the end user of the resources (e.g., communication appliance characteristics for bandwidth resources). Moreover, various resources may require delivery conditions that are unique and/or incompatible with other resources.

One exemplary application involving the management of resources relates to the operational management of contractual and transactional interactions between buyers, sellers, financial institutions and others involved in the exchange of products for purposes of commerce, which have typically been labor and time intensive. Generally, the processes of managing transactions and related allocation of financial resources between business entities have been unduly burdensome and inefficient.

Financial institutions employ transaction processing parameters that are unique to each institution. In addition, these transaction processing parameters typically need to be kept separate (and confidential), relative to other financial institutions. Often, transaction processing is dependent upon these parameters, which are specific to a particular financial institution involved in financing the transaction. In this regard, transaction processing for portions of a transaction that are related to a financial institution has generally been limited to implementation by a processing engine or system employed by the financial institution participating in the transaction.

When a transaction reaches the payment step, financial institutions for different parties to the transaction must interact with each other. This interaction typically involves complex agreements and associations that facilitate the transfer of funds. At times, there can be delays in payment or disputes regarding terms of payment. In addition, this process is highly susceptible to error. Interaction complexity, delay and error, as well as a multitude of other characteristics of transaction payment can cost one or more parties to a transaction (including financial institutions) a significant amount of funds.

Most industries are quite competitive and any cost savings are therefore important. Administrative costs are targeted for reduction as no revenue is directly generated from administrative functions. However, administrative costs associated with commercial transactions have been difficult to reduce in the current business environment with widely diffused data.

The above and other difficulties in the management and coordination of transactions have presented administrative and cost challenges to entities involved in various aspects of transactions, including financial institutions and others.

### SUMMARY

The present invention is exemplified in a number of implementations and applications, some of which are summarized below.

According to an example embodiment of the present invention, a computer-based system links, audits and generates electronic resource-allocation data for transaction data sets respectively pertaining to each of a multitude of transactions involving disparate transaction entities and related auditing and resource-allocation data. A database is configured for storing data sets respectively including rules for processing the transaction data sets and profile data for entities involved in the transactions, and correlation data for correlating received transaction data sets with a transaction to which the received transaction data sets apply, with rules for the transaction and with profile data for an entity involved in the transaction. A computer-based processing and allocation circuit correlates received transaction data sets with a particular transaction and with sets of rules and profile data for the transaction, using the stored correlation data, and audits initial ones of the transaction data sets using the correlated sets of rules and profiles. Based upon the audit, the allocation circuit generates electronic resource-allocation data for the initial transactions, and for one of the entities involved in a plurality of the transactions occurring over time, stores data representing selected aspects of the audited transaction data sets to develop an historical record of the transactions and provide tracking of attributes indicative of a resource-allocation rating for said one of the entities. The allocation circuit further adaptively generates updated rules pertaining to the one of the entities, using the historical record and the tracked attributes, and stores the updated rules in the data storage arrangement. The allocation circuit then audits additional transaction data sets using the correlated sets of updated rules and profiles and, based upon the audit, generates electronic resource-allocation data for the additional transaction data sets.

According to another example embodiment, a computer-based system is configured for linking, auditing, and generating electronic payment resource-allocation data for transaction data sets respectively pertaining to one of a multitude of transactions involving disparate transaction entities and different processing rules for each party. The system includes a data storage arrangement that stores entity-specific audit rules for processing the transaction data sets on behalf of each entity, credit resource allocation rules for providing funds to provide payment on behalf of each entity, and contract data specifying previously-defined contract terms for specific transactions. A tracking controller is configured to generate and store historical payment resource-allocation data for transaction data sets and transactions to which they pertain, the resource-allocation data including information for categorizing transactions, and for characterizing credit-based characteristics of the transactions. An adaptive rule controller is configured to adaptively generate updated allocation rules pertaining to each of a plurality of entities based upon the stored historical resource-allocation data. An auditing processor is configured to, for each received transaction data set, correlate the transaction data set with a particular entity, the entity's audit rules and updated credit allocation rules, and a contract involving the entity and pertaining to the transaction, use the correlated rules together with data in the transaction data set to audit the data set to determine: a condition of payment authorization on behalf of the particular entity, a condition of electronic funds allocation to the particular entity, and in response to the audit, generate data to facilitate electronic payment for the transaction.

According to another specific example embodiment, the present invention is directed to a computer-based system that audits data sets for transactions between parties to the transactions, and generates and controls electronic funds transfers for extending, managing and collecting credit-based payments. The system includes a computer processing and analysis arrangement and a database/memory management type of arrangement that stored sets of parameters useful for underwriting/auditing disparate parties to a multitude of transactions (e.g., the parameters are used as inputs to a configurable algorithm). This data is accessed by the computer processing and analysis arrangement, along with data about the parties and transactions for auditing and facilitating payment. The system thus operates under conditions specific to each transaction and each related transaction party, using the various parameters for dynamic configuration.

In a more particular embodiment, the above system is implemented as follows. The memory management arrangement is adapted to store and provide access to business rules for facilitating the transactions, and to store and provide access to profiles of the parties to the transactions, the business rules and the profiles being part of a data set and at least a part of the data set being accessible by the parties from respective locations that are remote from the system. The computer processing and analysis arrangement is programmed for auditing and facilitating payment for initial ones of the transactions as a function of the business rules and the profiles of parties involved in the initial transactions. Further, computer processing and analysis arrangement is implemented so that for one of the parties involved in a plurality of the transactions occurring over time, it develops a historical record of selected aspects of the transactions and tracks attributes indicative of a credit rating for said one of the parties. The computer processing and analysis arrangement adaptively develops, in response to the historical record of selected aspects and the tracked attributes, updated business rules and profiles pertaining to said one of the parties, and uses the updated business rules for auditing and facilitating payment for ongoing transactions.

In other aspects and embodiments, the present invention is directed to computer-implemented arrangements and methods which process and analyze data based on adaptively-updated information about the conditions for underwriting and/or contracting with entities involved in a business-to-business relationship. In this context, computer-program modules (to be executed by a computer structure) operate to perform steps relating to providing: updated profiles for one or more of the entities involved in a business-to-business relationship; updated business rules, e.g., for a party that requests different rules for itself based upon the credit rating that the computer system (or another external input) ascribes to the party; updated business rules for a party that requests different rules based upon the credit rating given to others (e.g., seller (to buyer/financier) or financier (based on buyer/seller to whom credit is extended)); and updated business rules for a party, e.g., based on new information presented to the computer system and incorporated into the adaptive analysis.

In yet other aspects and embodiments, the present invention is directed to computer-implemented arrangements and methods which process and analyze data based on adaptively-updated information by selectively using credit ratings of different parties based upon historical data; using known owed funds to a party to influence its credit rating (dependent-use credit rating of those owning the party to influence the party's credit rating); and incorporating additional underwriting claims for parties that have been involved as clients or representatives in the system's business-to-business environment.

As discussed and illustrated further herein, certain implementations of the invention use information that is adaptively-updated via a manual input, a fully-automated input and, in some instances, through a combination of manual and fully-automated inputs. Depending on the implementation, such updating can be implemented using relatively complex interfaces and/or recursive time-triggered and/or event-triggered CPU-programmed arrangements or, in less complex implementations, using very basic methodologies, for example, involving manual edits to stored data.

The above summary is not intended to describe each illustrated embodiment or every implementation of the present invention.

### BRIEF DESCRIPTION OF THE DRAWINGS

The invention may be more completely understood in consideration of the detailed description of various embodiments of the invention in connection with the accompanying drawings, in which:

FIG. 1 shows an arrangement and approach for processing payment for transactions using an adaptive audit and payment approach, according to an example embodiment of the present invention; and

FIG. 2 shows a flow diagram for transaction processing, according to another example embodiment of the present invention.

While the invention is amenable to various modifications and alternative forms, specifics thereof have been shown by way of example in the drawings and will be described in detail. It should be understood, however, that the intention is not necessarily to limit the invention to the particular embodiments described. On the contrary, the intention is to cover all modifications, equivalents, and alternatives falling within the spirit and scope of the invention as defined by the appended claims.

### DETAILED DESCRIPTION

The present invention is believed to be applicable to a variety of different types of transaction processing and management approaches, and has been found to be particularly useful for applications involving the auditing of payment and/or credit-related processing using historical transaction data. While the present invention is not necessarily limited to such approaches, various aspects of the invention may be appreciated through a discussion of various examples using these and other contexts.

According to an example embodiment of the present invention, a computer-based system adaptively audits transactions and facilitates payment (e.g., payment underwriting) for transactions between parties including at least one buyer and at least one seller for each transaction. The system includes a memory management arrangement that stores and provides access to business rules for facilitating the transactions, and that further stores and provides access to profiles of the parties to the transactions. These business rules and profiles are part of a data set, at least a part of which can be accessed by the parties from respective locations that are remote from the system. The system further includes a computer processing and analysis arrangement programmed for auditing and facilitating payment for initial ones of the transactions as a function of the business rules and the profiles of parties involved in the initial transactions. The computer processing and analysis arrangement also develops a historical record of selected aspects of the transactions involving one of the parties over time, and tracks attributes indicative of a credit rating for the party (and as applicable to a multitude of such parties). In response to the historical record of selected aspects and the tracked attributes, the computer processing and analysis arrangement adaptively develops updated business rules and/or profiles pertaining to the party, and uses the updated business rules for auditing and facilitating payment for ongoing transactions.

According to another example embodiment, the computer-based system audits payment for transactions involving an owing party (e.g., a buyer) using the updated business rules and/or profiles by selecting a payment funding source according to a credit rating for the owing party. For example, the owing party's business rules may specify different funding sources based upon its current credit rating, or according to rates associated with the credit rating. An owed party's business rules may also specify different funding terms (e.g., interest rate, credit limits) based upon updated business rules or profiles corresponding to a credit rating for an owing party on behalf of which credit is extended. As transactions are processed over time, the system adaptively modifies rules and/or profiles as appropriate based upon changing conditions relating to credit or other conditions, and this adaptively-developed information is used to process additional transactions.

In these and other contexts, adaptively developing updated business rules and/or profiles and using these rules/profiles to audit and facilitate payment may involve one or more of a multitude of different transaction-specific and/or party-specific processing functions, based upon the parties involved in the transaction and related transaction characteristics. That is, credit ratings and historical data for one or more of an owed party, an owing party, a financier, an underwriter, or combinations of such parties (and as may be applicable across different transactions), can be used for various transaction processing functions, depending upon business rules and/or profile information for parties to each transaction. In processing a multitude of transactions involving different parties, the computer-based system is afforded access to historical data applicable to many involved parties and, accordingly, a wealth of information for such adaptive development of rules and profiles, and related auditing and payment processing.

In some embodiments, certain profiles for one or more particular transaction parties such as buyers, sellers or financiers are managed by the system to provide a third-party overview of a transaction party's historical and current credit-based status, or of a status of a pool of credit held by one or more financiers. For instance, where a financier extends credit on behalf of a buyer, historical data is used to characterize that extension of credit and its effect upon the financiers' portfolio risk. Collectively applied across receivables for a particular financier (i.e., across individuals or entities in debt to financier), this approach is useful for providing an indication of the financier's ability to collect upon its receivables based upon historical and related information for each entity to which the financier has extended credit. Where a credit pool is involved, the risk of failing to collect a receivable is spread across multiple financial institutions participating in the pool, and further spread across multiple owing parties for which receivables are pooled as such. Moreover, as the computer-based system has access to historical data across multiple transaction types (e.g., involving consumer loans, revolving credit or even mortgages), an accurate representation of a financier/lender's debt profile is readily available.

Various embodiments described herein are applicable for use with a variety of transaction processing approaches. For instance, certain embodiments involve using adaptive auditing and payment processing with a system and approach such as that disclosed in U.S. patent application Ser. No. 11/151,747 (by Hahn-Carlson) entitled “Financial Institution-based Transaction Processing System and Approach” and filed Jun. 9, 2005. Other embodiments involve using adaptive auditing and/or payment with a system and approach as disclosed in U.S. Pat. No. 5,910,896 (also by Hahn-Carlson). Moreover, various example embodiments of the present invention are also implemented with a variety of payment processes involving, for example, credit-based payment, corporate payment credit cards, business-to-business transactions, bank-to-bank transactions, as well as related software and other processing functions carried out in connection with the same. In this context, the following discussion of the figures and the information shown therein may also be applied on connection with these patent documents.

As consistent with the claims and the above discussion, various embodiments are directed to allocating resources for transaction entities based upon historical resource allocation and related conditions. These resources may involve one or more of a variety different types of resources, including those identified above (e.g., energy, processing time, bandwidth), and historical behaviors of entities that use and/or provide the resources. The following discussion uses monetary resources (e.g., credit-based electronic funding for payment) in connection with multiple embodiments, which are exemplary of various types of resource allocation. For instance, some embodiments are applicable to adaptively developing an historical resource usage rating for a particular entity, such as an historical energy usage rating, that can be used in auditing further transactions involving the allocation of energy resources. In addition, various discussion herein uses terms such as buyers, sellers, parties to a transaction and others that are also generally applicable to similar terms such as those identifying transaction entities (users and providers of resources), and may be used to exemplify the same.

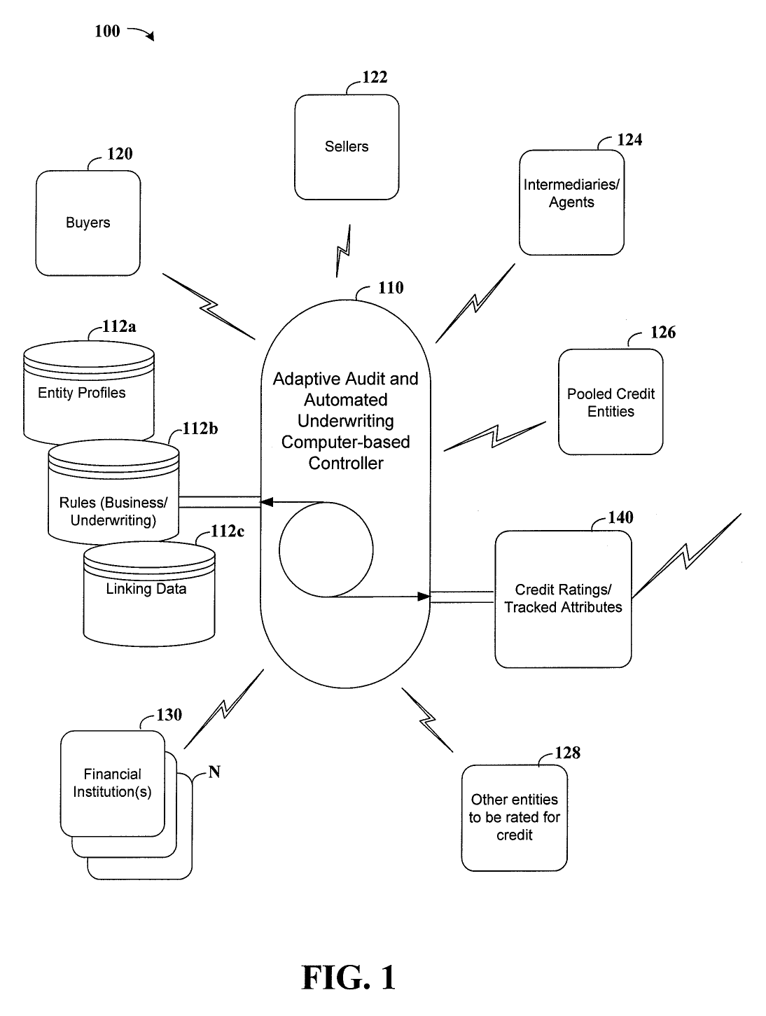

Turning now to the figures, FIG. 1 shows a system 100 for adaptive auditing and automated underwriting, according to another example embodiment of the present invention. The system 100 includes a computer-based controller 110 that is programmed to audit and underwrite (facilitate) payment for transactions using party profiles and business/underwriting rules stored at 112a and 112b that are adaptively developed by the controller using historical data made available by processing transactions for the parties and/or from external sources. These rules are used in connection with linking data at 112c, that is used to link incoming transaction data sets with these profiles, rules and related parties for a multitude of disparate transactions involving different and often unrelated parties, and one or more contracts pertaining to each transaction (e.g., using data-based identifiers and/or algorithm-type data to generate a link).

The system 100 processes a variety of transactions, including those for goods or services between buyers 120 and sellers 122, transactions between financial institutions 130-N, transactions between buyers or sellers and one or more of the financial institutions, and transactions involving other entities such as intermediary sellers or distributors (e.g., 124).

As transactions are processed, attributes of the transactions are tracked and provided at 140, either via the controller 110 or otherwise, and used in processing subsequent transactions. These tracked attributes may include, for example, characteristics relating to a payment history for a particular transaction party, the party's net debt, or net funds owed to the party.

The controller 110 processes the tracked attributes at 140 to develop profile and/or rule data at 112a and 112b, for use in processing additional transactions. In some applications, a party's rule data specifies that certain changes be made to the rules in response to certain historical conditions, and the controller 110 accordingly updates the rules as related historical information is received. In other instances, the controller updates one or both of rules and profiles for a particular party based upon the party's participation in transactions, and/or based upon other party's participation in transactions, as relative to ongoing transactions involving the particular party and to be processed by the controller. In still other instances, the controller 110 is programmed to identify trends or patterns relating to one or more transactions parties, and develop profile and/or rule data accordingly.

The controller uses the developed profile and/or rule data to audit transactions in a variety of manners. For example and in connection with certain embodiments, the controller uses developed business rules and transaction data to determine whether payment to a particular party is appropriate, given information in the transaction data (e.g., confirming receipt of goods). In these contexts, the audit can be effected in a multitude of manners, such as those described in the patent documents discussed and listed above.

In some instances, an external credit rating is provided at 140 as well for use in auditing transactions and facilitating payment at the controller 110. For example, such ratings may be available for a particular buyer or seller involved in a transaction processed by the controller 110, and are used in auditing and underwriting payment for transactions. These credit ratings may also be used in assessing the portfolio risk for a particular financier, by assessing the credit ratings of parties in debt to the financier and/or for which the financier holds receivables.

For certain embodiments, the controller 110 facilitates payment for transactions and groups a receivable value for the payment into a pool of credit managed by a pooled credit entity (or collective entities) 126, using adaptively-developed business rules and/or profiles. The receivable value is placed into a particular pool of credit based upon adaptively-developed business rules and/or profile information. In some instances, a financial entity owning a receivable value (e.g., a debt owed by a transaction party for a payment made on behalf of the party in a particular transaction) specifies that adaptively-developed business rules be used by the controller in placing the receivable value into a particular pool of credit. A particular pool of credit may also have rules associated with it to control the type of debt included with the pool, based upon a credit risk associated with a related indebted party.

In some applications involving pooled credit, business rules are adaptively evolved based upon characteristics of a particular credit pool. These characteristics may include, for example, tracked information pertaining to transaction parties whose owed (receivable) value is held in the credit pool, and can be used to assess the risk associated with the credit pool. As such, data is readily available to the controller 110 via its processing of transactions on behalf of such users, and the data can be used by the controller to develop an accurate representation of related credit/portfolio risk.

In addition to adaptively auditing transactions involving the indicated buyer, seller and financier entities, the controller may adaptively audit other entities 128 that are financially involved with transactions processed by the controller or with a party to a transaction processed by the controller. For instance, where a particular transaction party owes funds to a third-party lender that does not participate in transactions processed by the controller 110, historical information regarding that particular transaction party's transaction participation can be used to assess credit-based conditions for the third-party lender, as may be applicable to other transactions.

The controller 110 adaptively develops profiles and business rules stored at 112a and 112b using a variety of approaches. In one embodiment, the controller 110 uses a historical record of selected aspects and the tracked attributes to adaptively develop updated business rules and profiles for a financial party that provides funds to facilitate payment for the transactions. The development may involve adjusting the party's profile to reflect that party's credit portfolio risk or effective credit rating (i.e., from a third party's perspective), or to adjust the party's rules by which transactions are processed for the party (e.g., to direct that less risk be taken when underwriting credit, or that a greater interest rate be charged for underwriting credit).

In another embodiment, the controller 110 develops profiles for transaction parties involved in transactions, based upon characteristics of those transactions, and uses the developed profiles in ongoing (e.g., additional) transactions. For instance, as a buyer purchases goods and/or services, the controller 110 processes the transactions and has access to information relating to that party's credit status (i.e., amount of debt) and historical payment information. The controller 110 uses this information to adaptively develop a profile for the buyer and, subsequently, uses the adaptively-developed profile in processing additional transactions.

In some applications, the controller 110 audits and facilitates payment for transactions involving a particular owing party using funds owed to the owing party (e.g., receivables) to be processed by the controller for underwriting the payment. For instance, where a particular buyer or financial entity is owed funds by another party or otherwise owns receivables, the controller 110 uses this information in evaluating the extension of credit on behalf of the buyer for effecting payment in a transaction. If the buyer fails to pay, the controller 110 can hold funds provided by a party owing the buyer to cover the failed payment. In some instances involving such a scenario, the controller 110 thus underwrites payment made on behalf of such a buyer based upon a credit rating of a party owing funds to the buyer.

The controller 110 facilitates payment via the extension of credit using approaches, depending upon the application. For instance, in some applications, payment is made to a seller on behalf of a buyer for payables financing. In other applications, payment is made on behalf of a seller for receivables financing. Collection (for payments made) is from a buyer in either instance, or from a buyer's financial institution that has assumed the buyer's debt. For payables financing, business rules of the buyer are applied in making a decision to pay, relative to an audit or other approach, and the business rules from the seller may also be applied where appropriate given related rules and/or contract data. For receivables financing, business rules of the seller are applied to make a decision to pay, relative to an audit or other approach, and business rules from the buyer are correspondingly also applied for certain applications.

The controller 110 assesses fees for payments made in one or more of a variety of manners. One approach relates to business rules and, as appropriate, contract terms. For example, contracts between buyers and sellers may specify terms that, in addition to characterizing aspects of the goods and/or services to which the contract applies, characterize the assessment of fees relative to the extension of credit. For instance, considering an instance where payment to seller includes a 5% hold back amount until settlement from the buyer is received, where settlement from the buyer is not received in a timely manner, the 5% hold back amount is forfeited by a party or parties agreeing to pay the fees.

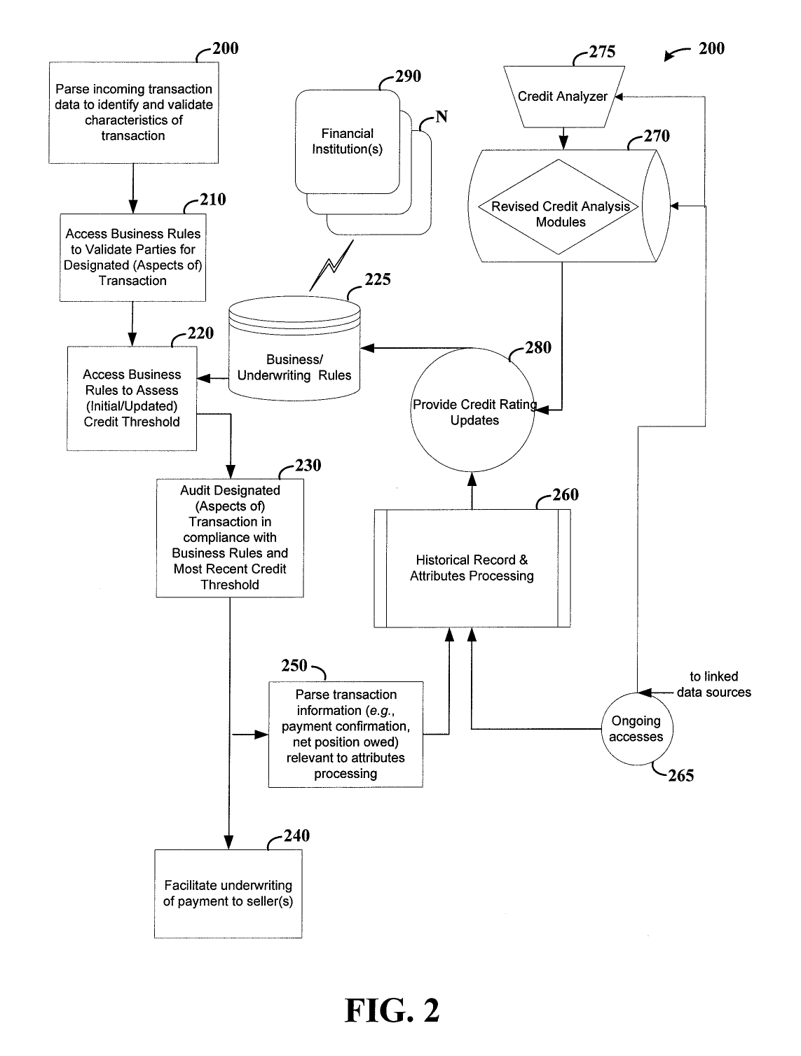

FIG. 2 shows a flow diagram for transaction processing, according to another example embodiment of the present invention. The approach shown in FIG. 2 may be implemented in a system such as that shown in FIG. 1, and is applicable to a variety of example embodiments.

At block 200, incoming transaction data is parsed to identify and validate characteristics of the transaction data and/or a transaction to which the data pertains. Such identification and validation may involve, for example, identifying the document as pertaining to a particular transaction and validating the document according to one or more of source, content and authentication information. Business rules relating to the identified transaction, as may be relevant to a particular transaction party (e.g., buyer, seller or financier), are accessed at bock 210 to validate transaction parties.

At block 220, business/underwriting rules at 225 are accessed in order to assess a credit threshold for a particular transaction, as related to one or more parties to the transaction. This credit threshold may be an initial type of threshold as may be applicable to a transaction party for which relevant historical data is limited or unavailable, such as a new transaction party for which transactions are initially processed. The business/underwriting rules at 225 are set in accordance with parties to transactions, including financial institutions 290-N that participate in aspects such as those relating to the financing (e.g., underwriting and/or payment) of transactions.

Using the credit threshold, the transaction to which the transaction data applies is audited at block 230 according to business rules as relevant to one or more transaction parties such as a financier specifying financing and/or payment conditions relevant to a credit threshold, or a transaction party that specifies funding or other options relating to the credit threshold. After the audit at block 230 and based thereupon, payment to one or more sellers is underwritten at block 240, generally by providing credit information that can be used to effect payment.

After the audit at block 230, information from the transaction is also used at block 250 (and beyond) for the development of historical data for one or more parties to the transaction. Transaction information such as payment confirmation, net position owed (for credit extended), receivables or payables data, and other characteristics is parsed at block 250 relevant to processing of transaction attributes. The parsed information is used by an historical record and attributes processing arrangement 260, together with other ongoing access information (e.g., credit reporting services such as Experian of Schaumburg, Ill. or D&B Corporation of Short Hills, N.J.), to develop historical information upon which business/underwriting rules can be based.

Revised credit analysis modules 270 further provide credit-based information relating to transaction parties, using one or more of manually-provided data inputs at a credit analyzer 275, ongoing accesses at 265 as discussed above, and business analysis information such as that relating to desirable or beneficial credit practices relative to one or more of lending, investments and other financial transactions. In some applications, the revised credit analysis modules 270 input and use external data from business analysis institutions such as Fair Isaac Corporation of Minneapolis, Minn. In some applications, the credit analyzer 275 also uses the ongoing accesses 265 in providing manual input.

This information developed by the historical record & attributes processing arrangement 260, as well as information from the revised credit analysis modules 270, is provided at 280 to augment, replace or otherwise modify the business/underwriting rules at 225. For instance, updated historical records and attributes provided at 260 can be used with revised credit analysis information provided at 270 to modify or augment the business/underwriting rules at 225. As further transactions involving one or more transaction parties with updated business/underwriting rules are processed, the updated rules at 225 are used in the audit at block 230.

In addition, updated business/underwriting rules reflecting historical data at 225 can be accessed and used by parties to the transaction and/or external parties for evaluating a variety of transaction-based aspects. For instance, historical data relating to payment history, available credit, net position owing or owed, or other information for buyers, sellers or financial institutions can be used to identify a particular transaction party's portfolio risk, propensity to pay (or not pay), available capital, expected capital (i.e., receivables versus payables), and other characteristics.

The following discusses another exemplary embodiment as directed the allocation of resources, which may be implemented in connection with one or both of FIGS. 1 and 2 as discussed above, using one or more different types of resources that are allocated. A computer-based system links, audits and generates electronic resource-allocation data for transaction data sets respectively pertaining to each of a multitude of transactions involving disparate transaction entities and related auditing and resource-allocation data.

A database is configured for storing data sets respectively including rules for processing the transaction data sets and profile data for entities involved in the transactions, and correlation data for correlating received transaction data sets with a transaction to which the received transaction data sets apply, with rules for the transaction and with profile data for an entity involved in the transaction.

A computer-based processing and allocation circuit correlates received transaction data sets with a particular transaction and with sets of rules and profile data for the transaction, using the stored correlation data, and audits initial ones of the transaction data sets using the correlated sets of rules and profiles. Based upon the audit, the allocation circuit generates electronic resource-allocation data for the initial transactions (e.g., for allocating a computer processing resource), and for one of the entities involved in a plurality of the transactions occurring over time, stores data representing selected aspects of the audited transaction data sets to develop an historical record of the transactions and provide tracking of attributes indicative of a resource-allocation rating for said one of the entities (e.g., the entity's performance in connection with the allocation). The allocation circuit further adaptively generates updated rules pertaining to the one of the entities, using the historical record and the tracked attributes, and stores the updated rules in the data storage arrangement. The allocation circuit then audits additional transaction data sets using the correlated sets of updated rules and profiles and, based upon the audit, generates electronic resource-allocation data for the additional transaction data sets (e.g., allocates additional computer processing resources).

While certain aspects of the present invention have been described with reference to several particular example embodiments, many involving monetary resources, those skilled in the art will recognize that many changes may be made thereto without departing from the spirit and scope of the present invention, aspects of which are set forth in the following claims.

What is claimed is:

1. A computer-based system for linking, auditing, and generating electronic payment resource-allocation data for transaction data sets respectively pertaining to one of a multitude of transactions involving disparate transaction entities and different processing rules for each party, the system comprising:
a data storage arrangement that stores entity-specific audit rules for processing the transaction data sets on behalf of each entity, that stores credit resource allocation rules for providing funds to cover payments made on behalf of each entity, and that stores contract data specifying previously-defined contract terms for specific transactions;
a tracking controller configured to generate and store historical payment resource-allocation data for transaction data sets and transactions to which they pertain, the resource-allocation data including information for categorizing transactions, and for characterizing credit-based characteristics of the transactions,
an adaptive rule controller configured to adaptively generate updated allocation rules pertaining to each of a plurality of entities based upon the stored historical resource-allocation data; and
an auditing processor configured to, for each received transaction data set,
correlate the transaction data set with a particular entity, the entity's audit rules and updated credit allocation rules, and a contract involving the entity and pertaining to the transaction,
use the correlated rules together with data in the transaction data set to audit the data set to determine: a condition of payment authorization on behalf of the particular entity, and a condition of electronic funds allocation for providing funds on behalf of the particular entity, and
in response to the audit and respectively-determined conditions of payment authorization and electronic funds allocation, generate data to facilitate electronic payment for the transaction.

2. The system of claim 1, wherein
the adaptive rule controller adaptively generates updated allocation rules by adaptively developing updated rules and profiles for a financial party that provides funds to fund electronic payment for the transactions, and
the auditing processor uses the updated rules and profiles for the financial party as inputs for auditing the data set to determine a condition of payment authorization on behalf of a particular entity sponsored by the financial party.

3. The system of claim 1, wherein the tracking controller is configured to develop a historical record of selected aspects of the transactions by tracking attributes indicative of a credit rating for a financial party that provides funds to facilitate payment for the transactions.

4. The system of claim 1, wherein the auditing processor is configured to use the correlated credit allocation rules to underwrite the extension of credit to provide credit-based payment for transactions on behalf of the participating entity.

5. The system of claim 1, wherein the auditing processor is configured to determine a condition of electronic funds allocation by using historical resource-allocation data to control the placement of receivables for the transactions in one of a plurality of pools of credit, based upon the credit-based characteristics of the transactions.

6. A computer-based system for linking, auditing, and generating electronic resource-allocation data for transaction data sets respectively pertaining to one of a multitude of transactions involving disparate transaction entities and related auditing and resource-allocation data, the system comprising:
a data storage arrangement that
stores data sets respectively including rules for processing the transaction data sets and profile data for entities involved in the transactions, and
stores correlation data for correlating received transaction data sets with a transaction to which the received transaction data sets apply, with rules for the transaction and with profile data for an entity involved in the transaction;
a computer-based processing and allocation circuit programmed for
correlating received transaction data sets with a particular transaction and with sets of rules and profile data for the transaction, using the stored correlation data,
auditing initial ones of the transaction data sets using the correlated sets of rules and profiles and, based upon the audit, generating electronic resource-allocation data for the initial transactions,
for one of the entities involved in a plurality of the transactions occurring over time, storing data representing selected aspects of the audited transaction data sets to develop an historical record of the transactions and provide tracking of attributes indicative of a resource-allocation rating for said one of the entities,
adaptively generating updated rules pertaining to said one of the entities, using the historical record and the tracked attributes, and storing the updated rules in the data storage arrangement, and
auditing additional transaction data sets using the correlated sets of updated rules and profiles and, based upon the audit, generating electronic resource-allocation data for the additional transaction data sets.

7. The system of claim 6, wherein
the transactions are payment-based transactions for which electronic funds are allocated and payment is generated, and
the rules and updated rules include underwriting criteria for ongoing transactions.

8. The system of claim 6, wherein the allocation circuit adaptively generates updated rules by adaptively developing updated rules and profiles for a financial party that provides funds to fund electronic payment for the transactions.

9. The system of claim 6, wherein the allocation circuit is configured to develop a historical record of selected aspects of the transactions by tracking attributes indicative of a credit rating for a financial party that provides funds to facilitate payment for the transactions.

10. The system of claim 6, wherein the allocation circuit is configured to develop a historical record of selected aspects of the transactions by tracking attributes indicative of a credit rating for one of the entities.

11. The system of claim 6, wherein the allocation circuit is configured to use the updated rules correlated to a participating entity to underwrite an extension of credit to provide credit-based payment for transactions on behalf of the participating entity.

12. The system of claim 6, wherein the allocation circuit is configured to
develop an historical record of selected aspects of financial transactions and track attributes indicative of a credit rating for a financial party that provides funds to facilitate payment for the transactions, and
use the credit rating of the financial party to audit an extension of credit to provide payment for ongoing transactions sponsored by the financial party.

13. The system of claim 6, wherein the allocation circuit is configured to develop an historical record of selected aspects of the transactions and track attributes respectively indicative of a credit rating for a financial party that provides funds from a pool of credit to facilitate payment for financial transactions.

14. The system of claim 6, wherein the allocation circuit is configured to
develop an historical record of selected aspects of the transactions and track attributes indicative of a credit rating for a particular buyer on behalf of which credit is extended to facilitate payment for transactions involving merchant offerings purchased by the buyer, and
store data to electronically pool receivables for the particular buyer in a pool of credit based on a credit rating of the buyer.

15. The system of claim 6, wherein the allocation circuit is configured to use an historical record of selected aspects of the transactions and tracked attributes indicative of a credit rating for a particular transaction party to classify the particular buyer relative to a pool of credit from which funds are provided for payment of transactions involving the particular transaction party.

16. The system of claim 6, wherein the allocation circuit is configured to use the historical record of selected aspects of the transactions and tracked attributes indicative of a credit rating for a particular transaction party to control the placement of receivables for the transactions in one of a plurality of pools of credit based upon the credit rating.

17. The system of claim 6, wherein the allocation circuit is configured to
adaptively develop a credit rating for a financial party that provides funds to facilitate payment for financial transactions as a function of receivables due to the financial party for the transactions, and
use the credit rating of the financial party in ongoing financial transactions involving the financial party.

18. A computer-based method for linking, auditing, and generating electronic resource-allocation data for transaction data sets respectively pertaining to one of a multitude of transactions involving disparate transaction entities and related auditing and resource-allocation data, the method comprising:
storing, in a database,
data sets respectively including rules for processing the transaction data sets and profile data for entities involved in the transactions, and
correlation data for correlating received transaction data sets with a transaction to which the received transaction data sets apply, with rules for the transaction and with profile data for an entity involved in the transaction;
operating a computer-based processing and allocation circuit for
correlating received transaction data sets with a particular transaction and with sets of rules and profile data for the transaction, using the stored correlation data,
auditing initial ones of the transaction data sets using the correlated sets of rules and profiles and, based upon the audit, generating electronic resource-allocation data for the initial transactions,
for one of the entities involved in a plurality of the transactions occurring over time, storing data representing selected aspects of the audited transaction data sets to develop an historical record of the transactions and provide tracking of attributes indicative of a resource-allocation rating for said one of the entities,
adaptively generating updated rules pertaining to said one of the entities, using the historical record and the tracked attributes, and storing the updated rules in the data storage arrangement, and
auditing additional transaction data sets using the correlated sets of updated rules and profiles and, based upon the audit, generating electronic resource-allocation data for the additional transaction data sets.
